(19) United States
(12) Patent Application Publication
(10) Pub. No.: US 2013/0117738 A1
(43) Pub. Date: May 9, 2013

(54) Server Upgrades with Safety Checking and Preview

(71) Applicants: Sean Lamont Grant Livingston, Kirkland, WA (US); Meher J. Abidi, Kirkland, WA (US); Ahmet Aktay, Bellevue, WA (US); Le Chang, Sammamish, WA (US); Vishwas Kulkarni, Woodinville, WA (US); Liping Liu, Bellevue, WA (US); Hongzhou Ma, Redmond, WA (US); John Edward Menges, Des Moines, WA (US); Randy D. Thomson, Redmond, WA (US); Patrick Simek, Redmond, WA (US); John Fan, Redmond, WA (US)

(72) Inventors: Sean Lamont Grant Livingston, Kirkland, WA (US); Meher J. Abidi, Kirkland, WA (US); Ahmet Aktay, Bellevue, WA (US); Le Chang, Sammamish, WA (US); Vishwas Kulkarni, Woodinville, WA (US); Liping Liu, Bellevue, WA (US); Hongzhou Ma, Redmond, WA (US); John Edward Menges, Des Moines, WA (US); Randy D. Thomson, Redmond, WA (US); Patrick Simek, Redmond, WA (US); John Fan, Redmond, WA (US)

(73) Assignee: Microsoft Corporation, Redmond, WA (US)

(21) Appl. No.: 13/288,297

(22) Filed: Nov. 3, 2011

(51) Int. Cl. G06F 9/44

(52) U.S. Cl. 717/168

(57) ABSTRACT

Upgrade control checks may be provided. A user may be notified that at least one upgrade is available. In response to receiving a selection of the at least one upgrade from the user, a check may be made to determine whether the at least one upgrade conflicts with an existing component. If no conflict is detected, the upgrade may be performed. If a conflict does exist, a repair may be attempted.

### BACKGROUND

Previews and safety checks of upgrades may be provided. In conventional systems, upgrades to a shared computer system occur when information technology specialists force a system wide update with no granular control of upgrade schedule. Components in the shared system normally must be upgraded together to provide consistency and durability of the data and objects within, and thus cannot be upgraded in a granular fashion. Additionally, such upgrades result in longer durations and resulting outages as more components need to be upgraded in the same upgrade session. In some situations, upgrades of the shared system do not allow end users to validate the complete effects of upgrade or allow end user accessible tools to prevent the upgrade if known issues are found.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Upgrade control checks may be provided. A user may be notified that at least one upgrade is available. In response to receiving a selection of the at least one upgrade from the user, a check may be made to determine whether the at least one upgrade conflicts with an existing component. If no conflict is detected, the upgrade may be performed. If a conflict does exist, a repair may be attempted.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing upgrade control checks; and

FIG. 3 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Upgrade control checks may allow the granular selection of shared computer system components to be upgraded without information technology specialist assistance. Users of a shared service, such as a collaboration service, may opt in to available upgrades in real-time. Such upgrades may include a new user interface, experience components, and/or shared objects such as databases. Furthermore, granular control of upgrades may allowed the shared system to provide both the prior, pre-upgrade iteration and the upgraded version such that both the prior capability and the new upgraded capability may be available per user choice.

The increased control over upgrades may result in creating a copy of a user's existing data and applying the upgrade to the copy. This may allow the user to preview and evaluate the effects of the upgrade in a non-destructive capacity. The upgrade control checks may use a rules-based ability to notify users of potential upgrade issues. The rules may assist the end user in fixing found problem areas and reduce the possibility of upgrade errors.

Upgrade control checks may provide the ability to perform upgrades of subsets of shared objects at different times from each other while system continues to work. Users may upgrade their own partition of data and objects on a self-service opt-in basis and those data partitions and objects while the system is in use by end users. The checks may further provide the ability to detect, before upgrade, potential issues and may allow users to self-repair before engaging in the upgrade process.

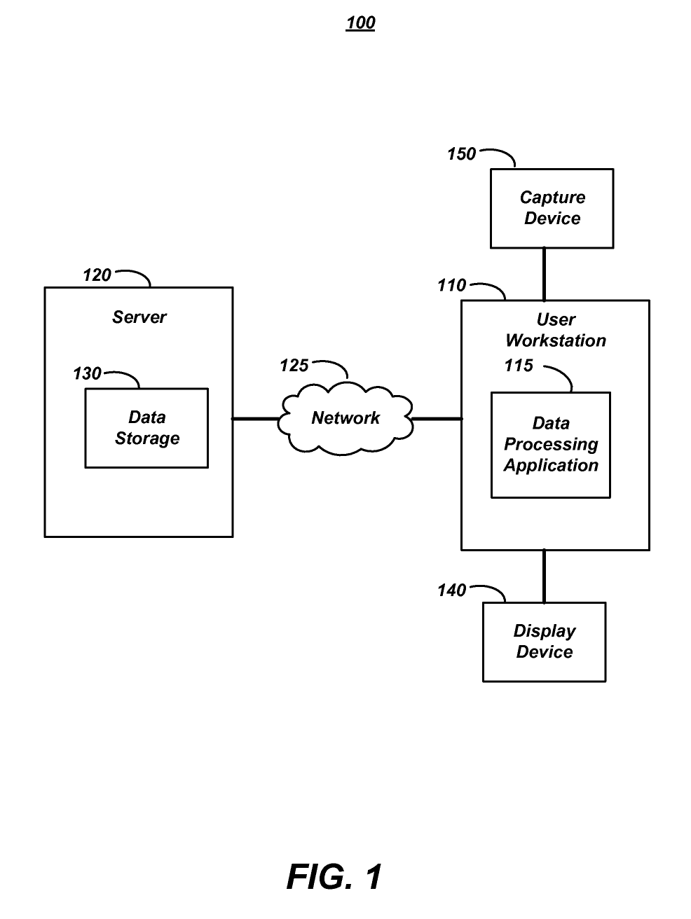

FIG. 1 is a block diagram of an operating environment 100 for providing upgrade control checks comprising a user workstation 110. User workstation 110 may comprise a data processing application 115 and may be operative to interact with a server 120 via a network 125. Data processing application 115 may comprise, for example a word processing, spreadsheet, presentation and/or other productivity application. For example, user workstation 110 may be operative to connect to a multi-user collaboration application 130 provided by a server 120 that may receive and process user requests from user workstation 110. User workstation 110 may be operative to output application data and/or user interfaces to a display device 140, such as a monitor and/or touchscreen. User workstation 110 may comprise, for example, an electronic communications device such as a computer, laptop, cellular and/or IP phone, tablet, game console and/or other device. User workstation 110 may be coupled to a capture device 150 that may be operative to record a user and capture spoken words, motions and/or gestures made by the user, such as with a camera and/or microphone. User workstation 110 may be further operative to capture other inputs from the user such as by a keyboard, touchscreen, stylus and/or mouse (not pictured). Consistent with embodiments of the invention, capture device 150 may comprise any speech and/or motion detection device capable of detecting the speech and/or actions of the user. For example, capture device 150 may comprise a Microsoft® Kinect® motion capture device comprising a plurality of cameras and a plurality of microphones.

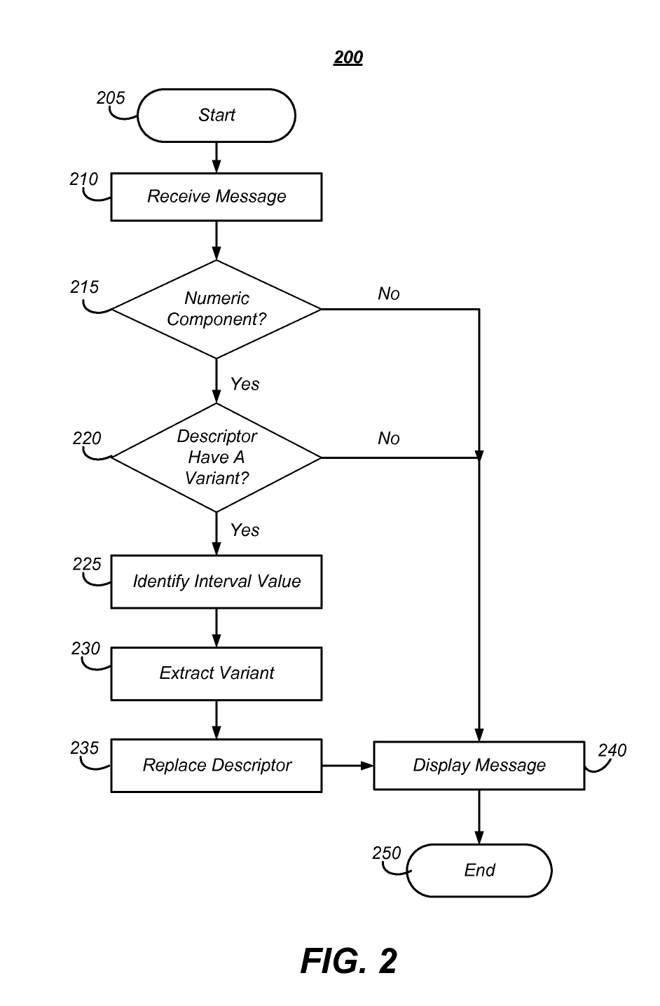

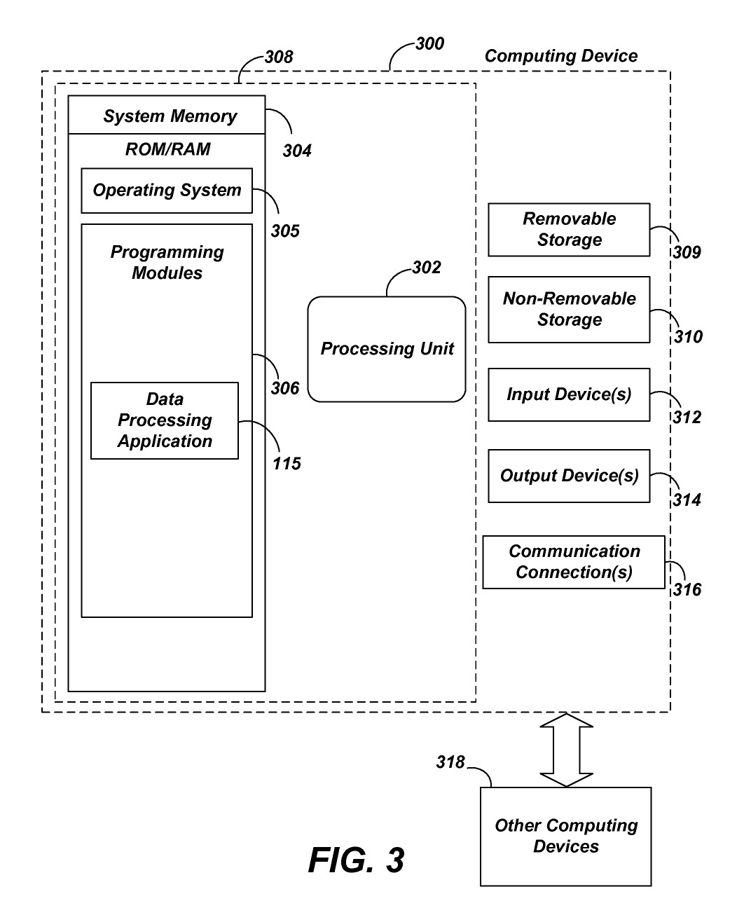

FIG. 2 is a flow chart setting forth the general stages involved in a method 200 consistent with an embodiment of the invention for providing upgrade control checks. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may notify a user that at least one upgrade to an application component is available. For example, the user may receive an alert within an application and/or an email from an administrator that an upgrade is available. Such an upgrade may comprise an upgrade to a functionality of the application component, an upgrade to a user interface/experience associated with the application component, and/or an upgrade to a data storage schema of the set of data.

Method 200 may then advance to stage 215 where computing device 300 may receive a selection of the at least one upgrade from the user. For example, the user may respond affirmatively to a dialog box asking if they would like the upgrade to proceed and/or select the upgrade from a list of available upgrades.

Method 200 may then advance to stage 220 where computing device 300 may create a copy of a data partition associated with the user. For example, collaboration application 130 may clone all data related to the user's workspace, including set(s) of data and/or configuration options. Such a copy may be created in a database available on server 120. Consistent with embodiments of the invention, the copy of the data partition may not be necessary, such as where the user elects to apply the upgrade to their production data set. Such a decision may be made, for example, for cosmetic upgrades to a user interface, or where the upgrade has already been evaluated on other data sets.

Method 200 may then advance to stage 225 where computing device 300 may determine whether the upgrade might conflict with an existing component and/or data set. For example, a plurality of upgrade rules may evaluate whether an existing component is incompatible with the upgrade, whether the user's data is unstable, corrupted, or in a format that may result in data loss from the upgrade, and/or whether the user has applied customization options (e.g., data viewing templates and/or localization/language options) that are not supported by the upgrade. Such conflicts may be associated with different levels ranging from informational (e.g., informing the user that some menu options have moved) to warning (e.g., the user's data has not been saved prior to initiating the upgrade) to errors (e.g., certain data may be corrupted and/or become inaccessible after the upgrade.) All such conflicts may be logged for review by the user and/or administrators of server 120.

If an upgrade conflict is detected at stage 225, method 200 may advance to stage 230 where computing device 300 may notify the user of the conflict. For example, collaboration application 130 and/or data processing application 115 may display a dialog box on display device 140 alerting the user to the conflict. Consistent with embodiments of the invention, such notifications may request the user's authorization to proceed with the upgrade and/or may recommend that the upgrade be applied to a copy of the user's data/environment rather than directly to the user's current set of data.

Method 200 may then advance to stage 235 where computing device 300 may attempt to repair the conflict in the data partition. For example, collaboration application 130 may save any unsaved changes to the user's data and/or attempt to restructure data in a database to comply with a new schema.

After attempting to repair the conflict at at stage 235, or if no conflict was detected at stage 225, method 200 may advance to stage 240 where computing device 300 may perform the at least one upgrade on the data partition associated with the user. For example, a new user interface may be exposed to the user and/or functionality of data processing application 115 and/or collaboration application 130 may be modified. Consistent with embodiments of the invention, server 120 may perform the upgrade to the user's data/user interface/experience while the user and/or other users of server 120 continue to work on documents and/or data associated with collaboration application 130. This upgrade may be performed on the user's original data set and/or on the copy of the data set created at stage 220.

Method 200 may then advance to stage 245 where computing device 300 may provide a link to the upgraded copy of the data partition to the user. For example, collaboration application 130 may provide a uniform resource locator (URL) to view the copied data through a web browser and/or via data processing application 115. This URL may differ from another URL that may provide access to the original data. This may allow the user to compare the pre-upgrade version of the data and/or user interface with the upgraded version. In cases where a copy of the data set was not made, as described above with respect to stage 220, stage 245 may be skipped.

Method 200 may then advance to stage 250 where computing device 300 may receive the user's feedback on the upgraded copy. For example, collaboration application 130 may determine whether the user approves of the upgraded copy of the data partition. If so, the original data partition associated with the user may be deleted. The user may also identify some and/or all of their data that may not have been properly upgraded and/or may have become corrupted by the upgrade. The user may correct the data in the copy and continue with the upgraded version and/or make changes to the data in the original and re-try the upgrade process. Method 200 may then end at stage 260.

An embodiment consistent with the invention may comprise a system for providing upgrade control checks. The system may comprise a memory storage and a processing unit coupled to the memory storage. The processing unit may be operative to notify a user that at least one upgrade is available, receive a selection of the at least one upgrade from the user, and determine whether the at least one upgrade conflicts with a component. In response to determining that the at least one upgrade does not conflict with the component, the processing unit may be operative to perform the upgrade.

Another embodiment consistent with the invention may comprise a system for providing upgrade control checks. The system may comprise a memory storage and a processing unit coupled to the memory storage. The processing unit may be operative to receive an instruction from a user to perform an upgrade of at least one application component and determine whether the upgrade comprises a conflict with a set of data associated with the user. In response to determining that the upgrade comprises a conflict with the set of data associated with the user, the processing unit may be operative to repair the set of data associated with the user. The processing unit may be further operative to create a copy of the set of data associated with the user, apply the upgrade to the copy of the set of data, provide access to the upgraded copy of the set of data to the user, receive an approval of the upgraded copy of the set of data from the user, and delete the original set of data.

Yet another embodiment consistent with the invention may comprise a system for providing upgrade control checks. The system may comprise a memory storage and a processing unit coupled to the memory storage. The processing unit may be operative to notify a user that at least one upgrade to an application component is available, receive a selection of the at least one upgrade from the user, create a copy of a data partition associated with the user, and determine whether at least one of a plurality of upgrade rules associated with the at least one upgrade comprises a conflict between a current aspect of the application component and an upgraded aspect of the application component. In response to determining that the at least one of a plurality of upgrade rules associated with the at least one upgrade comprises a conflict between the current aspect of the application component and the upgraded aspect of the application component, the processing unit may be operative to notify the user of the conflict and attempt to repair the conflict in the copy of the data partition. The processing unit may be further operative to perform the at least one upgrade on the copy of the data partition associated with the user, provide a link to the upgraded copy of the data partition to the user, determine whether the user approves of the upgraded copy of the data partition, and, in response to determining that the user approves of the upgraded copy, delete the original data partition associated with the user.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise operating environment 300 as described above. Methods described in this specification may operate in other environments and are not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include collaboration application 130. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 may perform processes and/or methods as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each and/or many of the components illustrated above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any component of operating environment 100 may operate via application-specific logic integrated with other components of the computing device/system on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing upgrade control checks, the method comprising:
notifying a user that at least one upgrade is available;
receiving a selection of the at least one upgrade from the user;
determining whether the at least one upgrade conflicts with a component; and
in response to determining that the at least one upgrade does not conflict with the component, performing the upgrade.

2. The method of claim 1, wherein the at least one upgrade is associated with at least one of the following: a user application, a user interface object, and an operating system.

3. The method of claim 1, wherein determining whether the at least one upgrade conflicts with the component comprises determining whether the at least one upgrade comprises a critical error level.

4. The method of claim 3, further comprising:
in response to determining that the at least one upgrade comprises the critical error level, attempting to repair the component prior to performing the upgrade.

5. The method of claim 4, further comprising:
determining whether attempting to repair the component was successful; and
in response to determining that attempting to repair the component was not successful, halting performance of the upgrade.

6. The method of claim 1, wherein the at least one upgrade is associated with a multi-user server.

7. The method of claim 6, wherein at least one second user retains access to the multi-user server during performance of the upgrade.

8. The method of claim 6, wherein at least one second user is not impacted by the performed upgrade.

9. The method of claim 6, wherein the at least one upgrade is associated with a component shared by a plurality of users.

10. The method of claim 9, further comprising retaining a plurality of versions of the shared component, wherein the upgrade is not performed on at least one version of the shared component.

11. The method of claim 10, wherein the user is associated with at least one second version of the shared component on which the upgrade is performed.

12. A system for providing upgrade control checks, the system comprising:
a memory storage; and
a processing unit coupled to the memory storage, wherein the processing unit is operable to:
receive an instruction from a user to perform an upgrade of at least one application component,
determine whether the upgrade comprises a conflict with a set of data associated with the user,
in response to determining that the upgrade comprises a conflict with the set of data associated with the user, repair the set of data associated with the user,
create a copy of the set of data associated with the user,
apply the upgrade to the copy of the set of data,
provide access to the upgraded copy of the set of data to the user,
receive an approval of the upgraded copy of the set of data from the user, and delete the original set of data.

13. The system of claim 12, wherein being operative to provide access to the upgraded copy of the set of data comprises providing a uniform resource locator (URL) to the upgraded copy of the set of data.

14. The system of claim 12, wherein the upgrade is associated with at least one of the following: an upgrade to a functionality of the application component, an upgrade to a user interface associated with the application component, and an upgrade to a data storage schema of the set of data.

15. The system of claim 12, wherein the processing unit is further operative to notify the user that the upgrade is available.

16. The system of claim 15, wherein the processing unit is further operative to provide the user with a time window in which to perform the upgrade.

17. The system of claim 16, wherein the processing unit is further operative to:
determine whether the time window in which to perform the upgrade has elapsed; and
in response to determining that the time window in which to perform the upgrade has elapsed, perform the upgrade without receiving a request to perform the upgrade from the user.

18. The system of claim 12, wherein being operative to determine whether the upgrade comprises a conflict with the set of data associated with the user comprises being operative to detect at least one of the following: a data integrity issue in the set of data, an unsupported localization of the at least one application component, and an unsupported customization of the at least one application component.

19. The system of claim 12, wherein the processing unit is further operative to:
determine whether the repair of the set of data was successful; and
in response to determining that the repair of the set of data was not successful, notify the user of the conflict with the set of data.

20. A computer-readable medium which stores a set of instructions which when executed performs a method for providing upgrade control checks, the method executed by the set of instructions comprising:
notifying a user that at least one upgrade to an application component is available, wherein the at least one upgrade is associated with at least one of the following: an upgrade to a functionality of the application component, an upgrade to a user interface associated with the application component, and an upgrade to a data storage schema of the set of data;
receiving a selection of the at least one upgrade from the user;
creating a copy of a data partition associated with the user;
determining whether at least one of a plurality of upgrade rules associated with the at least one upgrade comprises a conflict between a current aspect of the application component and an upgraded aspect of the application component;
in response to determining that the at least one of a plurality of upgrade rules associated with the at least one upgrade comprises a conflict between the current aspect of the application component and the upgraded aspect of the application component:
notifying the user of the conflict, and
attempting to repair the conflict in the copy of the data partition;
performing the at least one upgrade on the copy of the data partition associated with the user;
providing a link to the upgraded copy of the data partition to the user;
determining whether the user approves of the upgraded copy of the data partition; and
in response to determining that the user approves of the upgraded copy, deleting the original data partition associated with the user.
